(19) United States
(12) Patent Application Publication
(10) Pub. No.: US 2026/0128021 A1
(43) Pub. Date: May 7, 2026

(54) HARMONIC TONE PATTERNS FOR POINT OF SALE SYSTEM

(71) Applicant: TOSHIBA GLOBAL COMMERCE SOLUTIONS, INC., Durham, NC (US)

(72) Inventors: Abrahan ROMO RAMOS, Durham, NC (US); Salvador GOMEZ ALVAREZ, Durham, NC (US); Jordan FLORES, Durham, NC (US)

(73) Assignee: TOSHIBA GLOBAL COMMERCE SOLUTIONS, INC., Durham, NC (US)

(21) Appl. No.: 18/893,501

(22) Filed: Sep. 23, 2024

(51) Int. Cl. G10H 1/00

(52) U.S. Cl. CPC G10H 1/0025; G10H 2230/005

(57) ABSTRACT

Methods and systems of a point of sale controlling system are disclosed. In some aspects, a first musical note tone is assigned to a first checkout system and the first musical note tone is different from a second musical note tone assigned to a second checkout system. Next, in response to a first sound event has occurred for the first checkout system, the first musical note tone is only played for the first checkout system so that the first musical note tone is not played on the second checkout system and the second musical note is not played on the first checkout system.

### BACKGROUND

Checkout counters have grown in popularity. Various instruments and events within a point-of-sale system can generate alarms or alerts. Moreover, stores can have many point-of-sale systems that each are generating alarms or alerts at the same time, and the more systems being employed at a single location, the alarms become more numerous and frequent. As the store clerks become desensitized to frequent interruptions of these alarms, they often begin to ignore, miss or respond slower to the alarms. This phenomenon is referred to as alarm fatigue.

### BRIEF DESCRIPTION OF THE DRAWINGS

The objects and features of the present disclosure can be better understood with reference to the drawings described below, and the claims. The drawings are not necessarily to scale, emphasis instead generally being placed upon illustrating the principles of embodiments of the present disclosure. In the drawings, like numerals are used to indicate like parts throughout the various views.

FIG. 1A illustrates a perspective physical view of a point-of-sale checkout system/lane in accordance with some embodiments.

FIG. 1B illustrates a store with a series of point-of-sale checkout systems/lanes in accordance with some embodiments.

FIG. 2 illustrates a diagrammatic view of the point-of-sale checkout system/lane of FIG. 1 in accordance with some embodiments.

FIG. 3A illustrates a method of configuring a point-of-sale checkout system/lane in accordance with one embodiment.

FIG. 3B illustrates a method of operating a point-of-sale checkout system/lane in accordance with one embodiment.

FIG. 4 illustrates a method of operating a point-of-sale checkout system/lane in accordance with another embodiment.

### DETAILED DESCRIPTION OF THE EMBODIMENTS

Point-of-sale (“POS”) equipment are systems used to identify (e.g., via scanning bar codes) items associated with a user. The POS equipment includes a speaker designed to generate audible tones providing feedback for different events such as: error messages, alerts, message box, scanning items, and the like.

The current audible tone in POS equipment is a generic tone used for all kinds of events with the same tone frequency for all of them. Having an identical tone could make it harder for supervisors to detect missing scans or product theft using surrounding scan tones as cover. Customers could also verify more easily that every item scanned is being scanned in their account. Supervisors and cashier operators are very likely to develop alert fatigue. This alert fatigue will affect their ability to respond when abnormal events occur. Having a distinctive tone for different events will help alleviate this fatigue and reduce errors.

Generally, the present disclosure addresses alert fatigue induced by lack of proper audible alert design. As mentioned above, alert fatigue (sometimes also referred to “alarm fatigue”) is experienced when a repetitive, continuous and sometimes overwhelming number of alerts desensitizes the operator receiving them, leading to miss, ignore alerts or responding slower. In some embodiments, the POS equipment includes a speaker designed to generate audible tones providing feedback for different events such as: error messages, alerts, message box, scanning items, etc. This idea consists in defining, standardizing, and choosing the right tone for the right event and right POS unit. This means that an informative message box will not sound the same as an error message and so on. According to the present disclosure, the concept of assigning distinct scan tones to different POS units avoids confusion and/or misleading the customers/clerks hearing multiple identical tones from different POS units. The customers/clerks would be able to accurately identify when items are being scanned in their unit using a distinctive tone relative to tones of other units in proximity thereof.

Various examples and more details of the present disclosure will now be described below. The following description provides specific details for a thorough understanding and enabling description of these examples. One skilled in the art will understand, however, that the present disclosure may be practiced without many of these details. Additionally, some well-known structures or functions may not be shown or described in detail, so as to avoid unnecessarily obscuring the relevant description.

The terminology used in the description presented below is intended to be interpreted in its broadest reasonable manner, even though it is being used in conjunction with a detailed description of certain specific examples of the present disclosure. Certain terms may even be emphasized below; however, any terminology intended to be interpreted in any restricted manner will be overtly and specifically defined as such in this Detailed Description section.

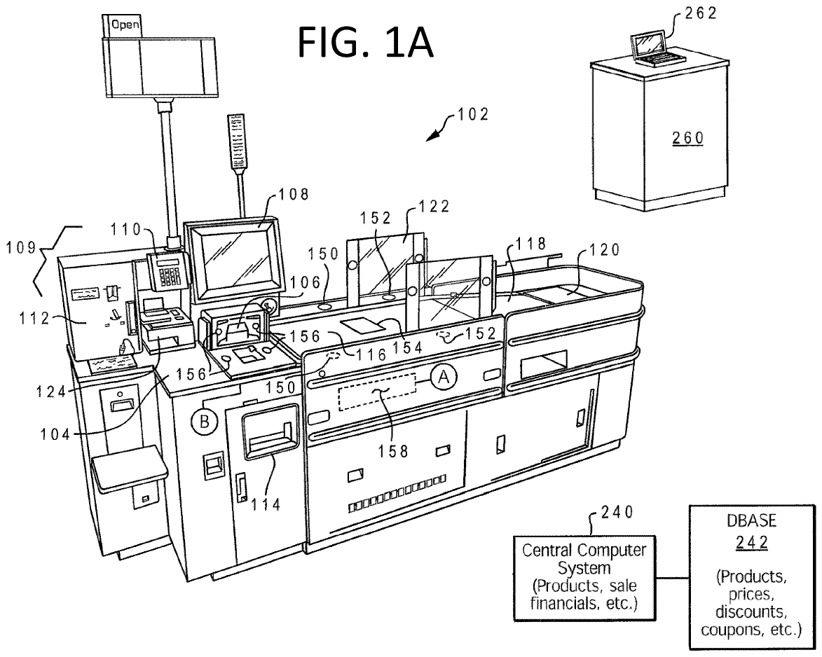

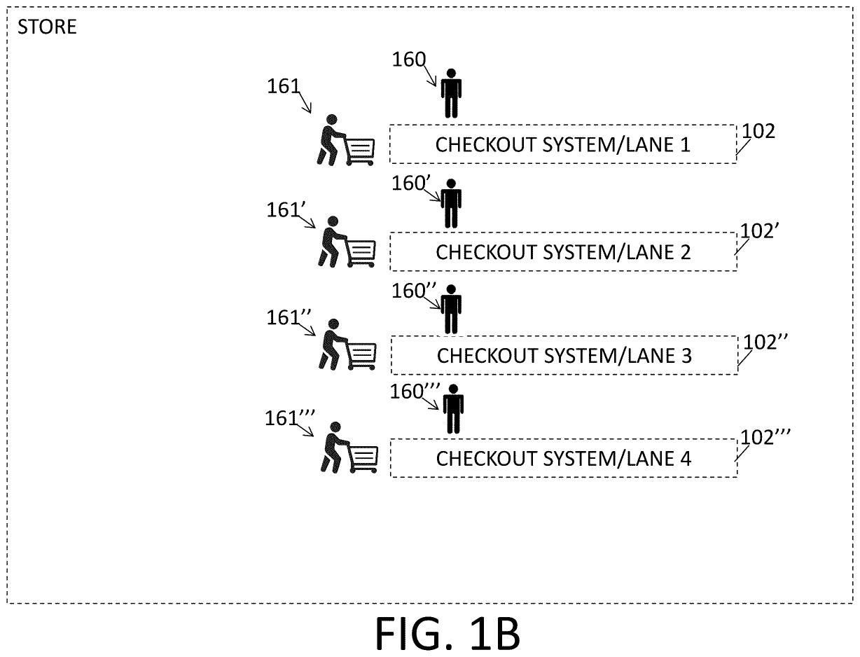

With reference now to the figures, and in particular FIG. 1A, there is illustrated an exemplary embodiment of a checkout system (and checkout system environment) within which the features of the present disclosure are implemented. The components of the checkout counter will now be discussed by FIG. 1A followed by FIG. 1B which illustrates multiple checkout lanes within proximity of each other.

It should be noted that the various components and specific configurations provided by FIGS. 1A and 1B are provided solely for illustration and not meant to imply any limitation on the actual checkout system within which the features of the present disclosure are applied/implemented.

FIG. 1A is a schematic diagram representation of an exemplary checkout system equipped with an audio system according to one embodiment. The checkout system 102 may be manned by a sales clerk as a checkout lane where the sale clerk checks out the customer or by the customer itself as a self-checkout lane. Checkout system 102 comprises counter 104, universal product code (“UPC”) reader (or scanner) 106, and display 108 for interactive customer communication. Checkout system 102 further comprises payment mechanism 109, which includes credit card reader 110, cash acceptor 112, cash dispenser 114 and/or a receipt unit 124. Further, checkout system comprises an entry conveyor 116, an out-feed conveyor 118, a bagging area 120, and/or a tunnel 122.

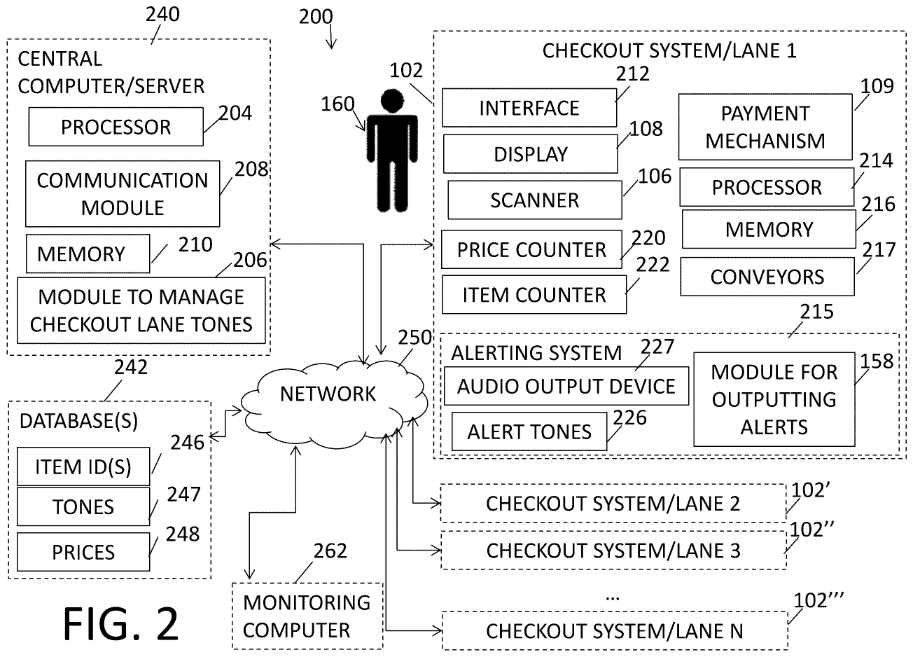

One of skill in the art will appreciate that the checkout device may include, for example, a computer system which controls the overall operation of the checkout device. Such a computer system may include, for example, a processor, memory (RAM and/or ROM), data storage devices (hard drives, removable storage devices, floppy drives, etc.), input devices (keyboard, microphone, trackpad, bar-code reader, UPC scanner, magnetic card reader, mouse, RF tag reader, touch screen and the like), audio system (e.g., speakers, etc.), and the like. The computer system may be in communication with one or more devices that together form the checkout system and/or checkout device. The computer system and the checkout systems are described in more detail later with regard to FIG. 2.

Referring back to FIG. 1A, in a retail environment, the checkout system 102 is connected/linked with a central computer system 240 (which represents a BOSS controller and a Point-Of-Sale (POS) Controller), which is discussed in more depth in FIG. 2. Additionally, an alerting system 158 of checkout system 102 is configured to include an audio output device (e.g., speakers, etc.), a database for alert tones, alerting modules/algorithm, etc.

The BOSS controller of central computer system 240 manages database 242 as well as point-of-sale functions of the checkout (and other cashier operated) systems, and also manages the pricing database for product.

The database may also include the various tones, frequencies, etc. that can be used for the checkout lanes.

It should be noted that the checkout system 102 may further include various other features, such as one or more sensors, microphones, cameras, lasers/LEDs, activators, or the like 156 to confirm the item being scanned, which may be located adjacent/proximate to the UPC reader 106 or other location at the checkout counter. Moreover, there may be additional devices 152 to assist in providing audio alerts. It, thus, should be understood that the present disclosure should not be limited to the embodiments shown in the FIGs.

One of skill in the art will also appreciate that the present disclosure may be used with any checkout device including a checkout lane having, for example, conveyor belts, stationary checkout systems, and any other checkout systems which generally include a register system and associated security devices, including self-checkout lanes or checkout lanes operated by an employee or artificial intelligence.

In one embodiment, an alerting system is thus illustrated in FIG. 1A works with entry conveyor 116 and/or out-feed conveyor 118. In this regard, the user (e.g., either a customer with a self-checkout counter or a clear with a checkout lane) scans a first item and an alert is then sounded. The user then places the item on the entry conveyor 116 which transports the scanned first item the bagging area 120 using the out-feed conveyor 118. If, when the user scans a first item and there is another error or alert, the system 158 will notify both the customer on the display 108 and/or via error/alert using a tone. Then, at this point, according to previous systems, the first item will not be allowed to move to the bagging area 120 and the next item will not be allowed to be scanned until this error is resolved.

FIG. 1B illustrates a store with multiple checkout lanes (lanes 1-4) 102, 102′, 102″, 102′″. As shown in FIG. 1B, there are customers 161, 161′, 161″, 161′″ checking out at checkout lanes 1-4 102, 102′, 102″, 102′″ via clerks/users 160, 160′, 160″, 160′″, respectively. In this system, there will be alert sounds issued for each of checkout lanes 1-4 102, 102′, 102″, 102′″ (based on errors, scanning confirmation beeps, etc.)—all alert sounds for all lanes around the same time as each other an identical tones. For example, a beep on lane 1 could be heard by clerk/user 160′ of lane 2 causing confusion for the clerk/user 160′. In this regard, the same tone being used by all lanes at the same time will cause confusion or accidental misuse of the checkout lanes because of the misunderstanding because all tones of all lanes are the same (or similar) and can be heard back all of the other lanes.

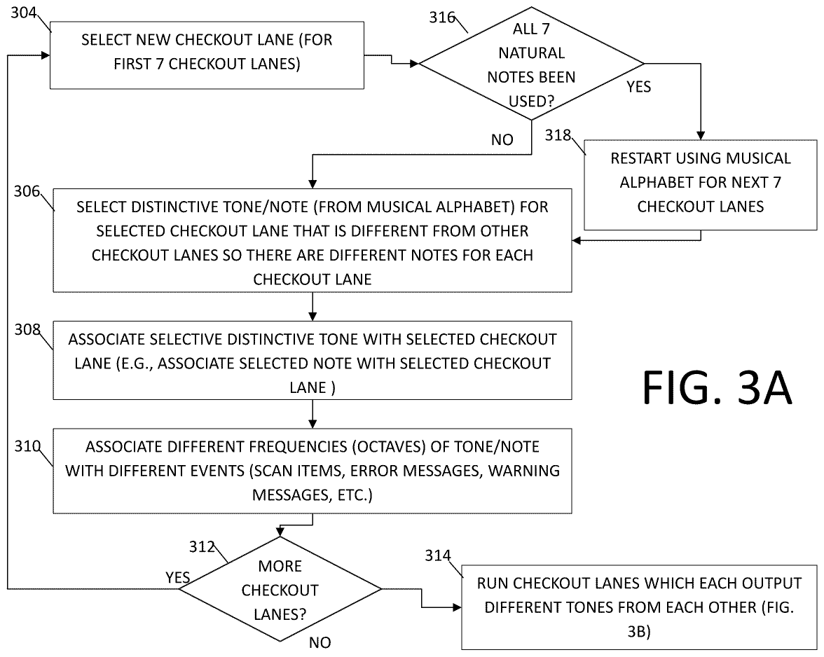

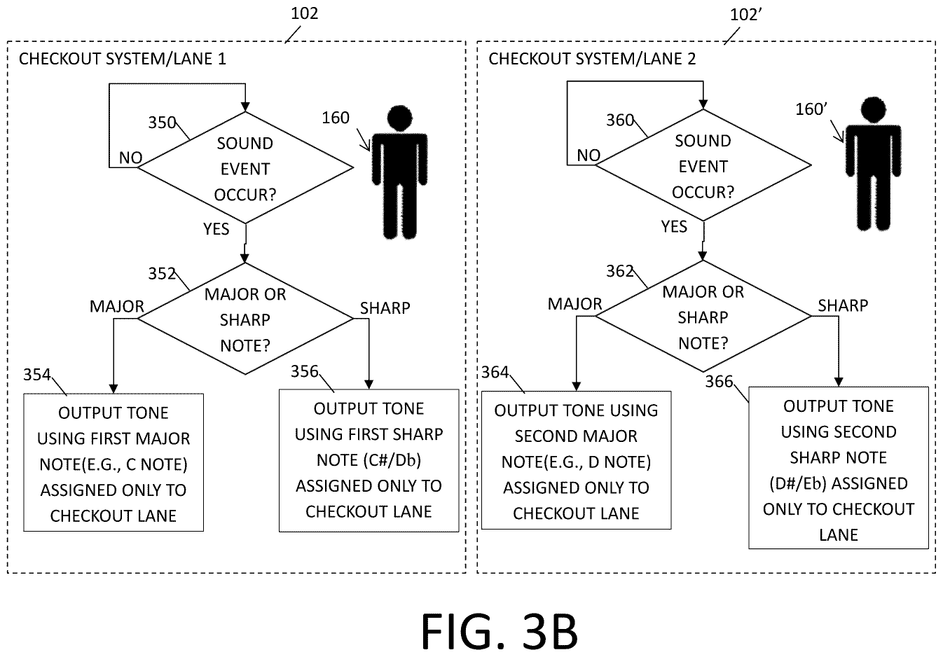

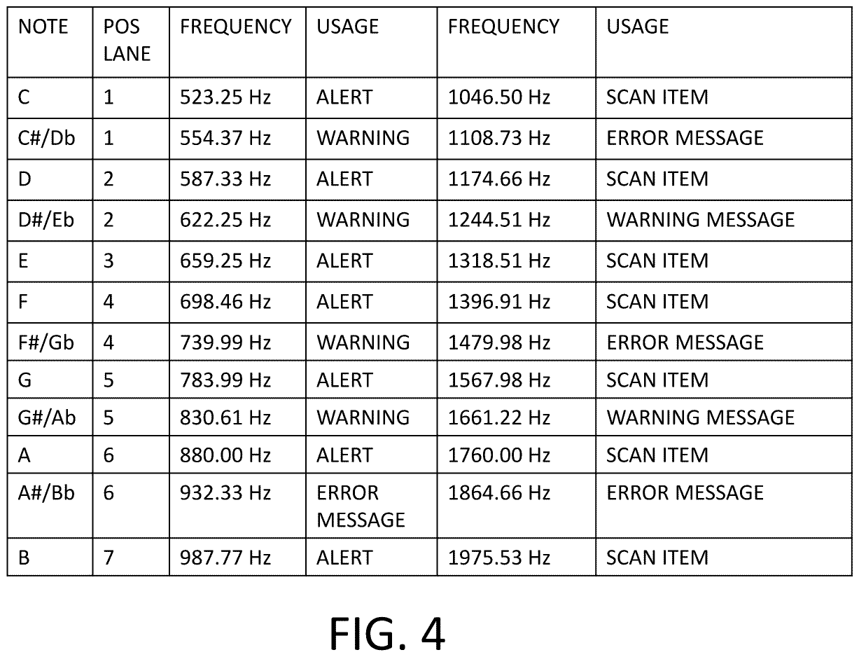

FIG. 2 illustrates a system 200 which can include the checkout system 102, the central computer system 240, database(s) 242, the monitoring computer 262, and a network 250. Each of these components are discussed below in connection with the description of FIGS. 3 and 4.

Generally, in FIG. 2, the checkout system 102 includes the scanner 106, display 108, and payment mechanism 109 along with an interface 212, processor 214, memory 216, conveyors 217, counters (price counter 220, item counter 222, etc.) and an alerting system 215. The alerting system 215 is discussed more later herein.

The checkout system 102 may be similar to the checkout system 102 of FIG. 1. For example, the scanner 106 is configured to scan items electronically and output audio tones to the user to indicate an item has been scanned or output tones to indicate an error.

The interfaces 212 are configured to allow the users to input data to the checkout system 102 and to display data and messages to the users. The interface 212 may be any software or hardware means to receive input from the user, such as a software graphical user interface (“GUI”) which is configured to allow a user to input data into the fields and also output data to the user. The interface 212 may be interactive to allow the user to interact with the checkout system 102 via a touch screen. The interfaces 212 may be stored on the checkout system 102 or remotely via the central computer system 240.

The processor 214 of the checkout system 102 is configured to execute computer readable instructions stored in memory 216 to perform one or more method steps discussed in FIGS. 3 and 4. For example, the processor 204 of the checkout system 102 is configured to read and execute instructions from memory 216 for the alerting module 158 to output distinctive audio tones between each various lanes. Each of the steps discussed herein may be programmed to the checkout system 102 to perform the specific steps recited herein.

The payment mechanism 109 is a device which is allowed to receive payments from the user which may be cash payments, credit card payments, or any other physical or electronic payments. The payment mechanism 109 may be connected to another network (not shown) which is configured to authenticate and approve the user's payments, such as an automated clearing house (ACH) network.

The conveyers 217 includes the entry conveyer 116, the out-feed conveyer 118, and/or any other conveyer or moving platform. The conveyers 217 may be controlled by a module to move conveyers (not shown).

The alerting system 215 includes an audio output device 227 (e.g., speakers), a module for outputting alerts (“alerting module”) 158, alert tones 226 and/or the like, according to some embodiments.

The audio output device 227 is any device which may include speakers or any other device configured to output audio. The audio output device 227 is connected to the system so that the speakers output the sounds that can be heard by the system 102 (and potentially other systems nearby).

The alerting module 158 is a software program stored in memory in the POS checkout system 102 (as shown in FIG. 2) or may be stored over a network on a server 240 or in a database 242. The alerting module 158 is configured to execute the steps of FIGS. 3A-3B to receive the assigned tone to the POS checkout system 102 and output the desired tone by executing the alert tones 226 assigned to the POS checkout system 102. The alerting module 158 may be called by the processor 214 of the POS checkout system 102 and/or of the processor 204 of the server 240 to execute one or more functions detailed in FIGS. 3A-3B.

The alert tones 226 may be any musical tone selected from the musical alphabet of C, D, E, A, B, and also includes sharp or minor notes of C #/Db, D #/Eb, E, F #/Gb, G #/Ab, A #/Bb. The alert tones 226 may be stored in the POS checkout system 102 (as shown in FIG. 2) or may be stored over a network on a server 240 or in a database 242. The alert tones 226 may be musical files that when executed plays a sound at the desired tone.

The functioning of the checkout system components are discussed more in depth with regard to FIGS. 3 and 4.

As mentioned above, the checkout system 102 is communicatively connected to the central computer system 240. The central computer system 240 includes a processor 204, memory 206, a communication module 208, and a module to manage the checkout systems 210. These components are discussed below.

The processor 204 is configured to execute computer readable instructions stored in memory 206 to perform one or more method steps discussed herein. For example, the processor 204 of the central computer system 240 is configured, via the module to manage the checkout system 102, to manage the operations of the checkout system including ensuring the software of the checkout system 102 is updated, recording data and transactions, ensuring the checkout system 102 is running appropriately, etc. It should be noted that any or all of the alerting system 215 may be executed by the central computer system 240 instead of or in conjunction with the checkout system 102 and the present disclosure should not be limited to components of the alerting system 215 being run only on the checkout system 102, as illustrated in FIG. 2. The central computer system 240 may be any computer or server that is connected to the checkout system 102, the database 242, and/or the monitoring computer 262 via a network 250, such as via a LAN or WAN, via a direct wired connection, via a short-range wireless connection, and/or the like.

The communication module 208 of the central computer system 240 is configured to communicate data between the central computer system 240, the database 242, the checkout system 102, and the monitoring computer 262 via the network 250. The communication module 208 is configured to access components on the central computer system 240 in combination with the processor 204 and memory 210.

The database 242 includes various items that the checkout system 102 can query including item IDs 246, tones 247 of the items, and prices 248 of the items. These items 246, 247, 248 in the database 242 can be created and updated regularly via the central computer system 240.

The monitoring computer 242 is configured to monitor the second-by-second scanning by each checkout system 102 attached to the monitoring computer 262. The monitoring computer 262 can be manned by an employee and connected with the checkout system 102 directly or over the network 250. The monitoring computer 262 is configured to receive any error or security messages/alerts relating to the checkout system 102. For example, if the user scans an item and such item is not verified, the monitoring computer 262 may be notified. The monitoring computer 262 is also configured to determine if the checkout system 102 is running properly, and can enable or disable one or more or all of the functions of the checkout system 102. The monitoring computer 262 can further determine if the tones of the lanes need to be adjusted so that each lane is more distinctive.

FIGS. 3A-3B illustrate method of alerting clerks/users at a retailer according to various embodiments.

First, FIG. 3A illustrates a method of configuring a point-of-sale checkout system/lane in accordance with one embodiment. In this regard, the checkout system 102 may be located at any retailer or store that allows transactions, such a grocery stores, merchandise stores, clothing stores, and any other location which allows for a transaction to occur.

First, in block 304, the system selects one of a plurality of checkout lanes to configure the audible alerts for that selected checkout lane.

In block 306, the system selects a distinctive tone/note from a musical alphabet for the selected checkout lane. The distinctive tone/note that is selected for the selected checkout lane will be unique to that selected checkout lane so that it is different from all other checkout lanes. The tones/notes that may be selected are shown in FIG. 4 and for each checkout lane, only one of the notes is selected therefor, in some embodiments. For example, for selected checkout lane 1, the system may select musical note C (with all octaves thereof) but for checkout lane 2, the system may then select musical note D.

In block 308, the selected distinctive tone/note is associated with the selected checkout lane. This can be done by updating software at the selected checkout lane of the POS itself or via a database 242 or server 240. In this regard, the selected checkout lane will then output through its audio output device 227 (e.g., speakers), the selected tones/note.

Accordingly, using the above example, for the selected checkout lane the audio output device 227 (e.g., speakers) will only output sounds in the C note musical alphabet. In this regard, for the selected checkout lane, when the selected checkout lane will output sounds for scanning an item using the 1046.50 Hz frequency or C sharp (C #/Db) notes at 1108.73 Hz. In this regard, only these sounds will be used by the selected checkout lane so that whenever events at this selected checkout lane occur, the clerk or user of selected checkout lane will know it is for his/her checkout lane and not from another checkout lane.

Also, it should be understood that the selected checkout lane can have varying events and thus, the system can output different octave sounds of the C major note sounds for these events and thus, still output sounds within the C note family. For example, for scanning an item, the system can beep using C major at 1046.50 Hz frequency (as mentioned above) but can output a beep at a different octave of the C major at 523.25 Hz. In this regard, the clerk/user of the selected checkout lane will be able to recognize that this is still within the C note family.

Thus, the POS software uses a call for a beep or tone, depending to their programming language. It is possible in all common languages to choose a specific oscillation frequency (tone) and the tones selected for this purpose are recommended to be located around 1000 Hertz that will ensure audible for most humans within human range (20 hz-20,000) and is also high enough to propagate clearly on noisy environments. Basic music theory helps choose the specific frequencies that are both clearly audible and pleasant to hear together in a loud environment.

The present approach is to choose major scales that are associated with happier and positive moods. Using the C major scale as reference the suggested tone assignment for tones and usage is shown in FIG. 4.

In FIG. 4, error and warning messages are on purpose assigned to notes outside the C Major scale, that should cause additional awareness that something is different and wrong to the repetitive and harmonic pattern from the POS item scan. The number of tones is limited to ensure it is within an optimal listening range around center frequency of 1000 Hertz. In environments in which louder music is expected, an alternative tone assignment pattern could be advisable, such as using a least popular scale, like A Major to avoid similar tones being overheard from the music.

Moreover, in FIG. 4, the 7 checkout lines are shown having a distinctive item scan tone so that none of the checkout lines has the same tone or note. The checkout lanes in the example of FIG. 4 are physically arranged in a pattern so that checkout lane 1 is adjacent to checkout lane 2, which is then adjacent to checkout lane 3, and so on. In this regard checkout lane 7 is farthest from checkout lane 1. If there are more than 7 lines, the pattern repeats using the same note assignment sequence to avoid machines with same tone to be located one next to the other. For example, using the example of FIG. 4, if there are checkout lanes 8-14, checkout lane 8 will be assigned C note, checkout lane 9 will be assigned D note, and the like so that each the lanes that have the same notes are at least 7 lanes away from each other which is the farthest spacing that the lanes can be relative to each other.

Referring back to FIG. 3A, in block 310, the system associates the different frequencies (octaves) of notes/tones with the different events (scan item, warning message, error message, etc.). This is done by saving the tone/note codecs to the POS memory, or in the database or server while also assigning the tone/note codecs to the respective checkout systems/lanes.

In block 312, the system determines if there are other checkout systems/lanes to process and assign notes. If so, then system will return to block 304; otherwise, the system will proceed to block 314 where the checkout lanes uses the assigned notes, as described in more depth with regard to FIG. 3B, discussed later herein.

In block 316, when the system determines that all 7 notes of the musical alphabet (A through G) have been assigned for a series of 7 checkout lanes, the system continues to block 318. If there are additional checkout lanes out of the 7 checkout lanes, then system will proceed to block 306 to assign musical notes for additional checkout lanes. Otherwise, if all 7 checkout lanes have all 7 notes assigned, the system will proceed to block 318 where the notes assignment process is restarted and the patterns are restarted, as described above.

FIG. 3B details the use of the checkout lanes are explained. In FIG. 3B, there are two checkout systems/lanes 102, 102′ shown but it should be known that there could be 7 or more systems/lanes.

In blocks 350-356, a first checkout lane 102 executes the functions shown, and in blocks 360-366, a second checkout lane 102″ executes the functions shown.

First, in block 350, the system determines if a sound event occurs, such as if an item has been scanned, an error message is being generated, or any other event where a sound is assigned to such event. If so, the system determines, in block 352, what note is assigned to such sound event—whether it is a major note or a sharp note. If the system determines that the note is a major one (e.g., C, D, E, A, B, etc.), the system will play the major note using the audio output device on the checkout lane 102, as shown in block 354. If the system determines that the note is a sharp or minor note (e.g., C #/Db, D #/Eb, E, F #/Gb, G #/Ab, A #/Bb, etc.), the system will also play the sharp or minor note using the audio output device on the checkout lane 102, as shown in block 356. For example, the checkout lane a 102 plays C note (major) when a scan event occurs and plays C #/Db notes (sharp/minor) when an error or warning occurs, while the checkout lane 2 102′ plays D note (major) when a scan event occurs and plays D #/Eb notes (sharp/minor) when an error or warning occurs. In this regard, the C note family is only played on the checkout lane 1 (102) while at the same time, the D note family is only played on the checkout lane 2 (102′). Thus, at the same time, both checkout systems 102, 102′ will not play the same musical note tones and thus, the user 160, 160′ of the checkout systems/lanes 102, 102′ will only hear their musical tones knowing when events are happening only on their system/lane 102, 102′ and not being confused between sounds issued from other lanes.

In some embodiments, the POS devices or checkout systems could “self-configure” themselves by listening to each other and the sounds the other checkout systesm are outputting and adjusting accordingly. In this regard, if checkout lane 1 is outputting a first tone, the checkout lane 2 could hear such first tone and automatically change to a second tone different from the first tone so that the user of checkout system 2 hears a different tone from checkout system 1. This may continue dynamically so that the checkout systems output tones and sounds that are unique so no other checkout systems (or systems other than checkout systems) output the same sounds as themselves. In this way, the user of the checkout system will hear sounds unique to only their checkout system. This can be done using artificial intelligence engines and microphones configured to listen to sounds ambient to the checkout system. When the checkout system hears the first sound, it compares such sound or tone to sounds and tones prestored on the checkout system and then outputs sounds or tones that are predetermined to be different from the heard sounds and tones. For example, if checkout system 1 hear checkout system 2 output a first tone of D note being output, checkout system 1 will identify using A note so that it is different from checkout system 2.

Unless the context clearly requires otherwise, throughout the description and the claims, the words “comprise,” “comprising,” and the like are to be construed in an inclusive sense, as opposed to an exclusive or exhaustive sense; that is to say, in the sense of “including, but not limited to.” As used herein, the terms “connected,” “coupled,” or any variant thereof, means any connection or coupling, either direct or indirect, between two or more elements; the coupling of connection between the elements can be physical, logical, or a combination thereof. Additionally, the words “herein,” “above,” “below,” and words of similar import, when used in this application, shall refer to this application as a whole and not to any particular portions of this application. Where the context permits, words in the above Detailed Description using the singular or plural number may also include the plural or singular number respectively. The word “or,” in reference to a list of two or more items, covers all of the following interpretations of the word: any of the items in the list, all of the items in the list, and any combination of the items in the list.

The above detailed description of embodiments of the present disclosure is not intended to be exhaustive or to limit the present disclosure to the precise form disclosed above. While specific embodiments of, and examples for, the present disclosure are described above for illustrative purposes, various equivalent modifications are possible within the scope of the present disclosure, as those skilled in the relevant art will recognize. For example, while processes or blocks are presented in a given order, alternative embodiments may perform routines having steps, or employ systems having blocks, in a different order, and some processes or blocks may be deleted, moved, added, subdivided, combined, and/or modified to provide alternative or sub-combinations. Each of these processes or blocks may be implemented in a variety of different ways. Also, while processes or blocks are at times shown as being performed in series, these processes or blocks may instead be performed in parallel, or may be performed at different times. Further any specific numbers noted herein are only examples: alternative implementations may employ differing values or ranges.

The teachings of the present disclosure provided herein can be applied to other systems, not necessarily the system described above. The elements and acts of the various embodiments described above can be combined to provide further embodiments.

Any patents and applications and other references noted above, including any that may be listed in accompanying filing papers, are incorporated herein by reference. Aspects of the present disclosure can be modified, if necessary, to employ the systems, functions, and concepts of the various references described above to provide yet further embodiments of the present disclosure.

These and other changes can be made to the present disclosure in light of the above Detailed Description. While the above description describes certain embodiments of the present disclosure, and describes the best mode contemplated, no matter how detailed the above appears in text, the present disclosure can be practiced in many ways. Details of the system may vary considerably in its implementation details, while still being encompassed by the present disclosure disclosed herein. As noted above, particular terminology used when describing certain features or aspects of the present disclosure should not be taken to imply that the terminology is being redefined herein to be restricted to any specific characteristics, features, or aspects of the present disclosure with which that terminology is associated. In general, the terms used in the following claims should not be construed to limit the present disclosure to the specific embodiments disclosed in the specification, unless the above Detailed Description section explicitly defines such terms. Accordingly, the actual scope of the present disclosure encompasses not only the disclosed embodiments, but also all equivalent ways of practicing or implementing the present disclosure under the claims.

While certain aspects of the present disclosure are presented below in certain claim forms, the inventors contemplate the various aspects of the present disclosure in any number of claim forms. For example, while only one aspect of the present disclosure may be recited as a means-plus-function claim under 35 U.S. C sec. 112(f), other aspects may likewise be embodied as a means-plus-function claim, or in other forms, such as being embodied in a computer-readable medium. (Any claims intended to be treated under 35 U.S.C. § 112(f) will begin with the words “means for”.) Accordingly, the inventors reserve the right to add additional claims after filing the application to pursue such additional claim forms for other aspects of the present disclosure.

What is claimed is:

1. A method comprising:
storing a first musical note tone assigned to a first checkout system, wherein the first musical note tone is different from a second musical note tone assigned to a second checkout system;
determining that a first sound event has occurred for the first checkout system; and
playing the first musical note tone for the first checkout system so that the first musical note tone is not played on the second checkout system and the second musical note is not played on the first checkout system.

2. The method of claim 1, wherein the first musical note tone is selected from a musical alphabet, and
wherein the second musical note tone is selected from the musical alphabet but is different from the first musical note.

3. The method of claim 2, wherein the first musical note tone is selected from C, D, E, F, G, A, B, and wherein the second musical note tone is also selected from C, D, E, F, G, A, B.

4. The method of claim 2, further comprising:
assigning a third musical note tone to the first checkout system;
assigning a fourth musical note tone to the second checkout system;
wherein the first and second musical note tones are a musical major notes selected from C, D, E, F, G, A, or B;
wherein the third musical note tone is a musical sharp or minor version of the first musical note tone and is selected from C #/Db, D #/Eb, E, F #/Gb, G #/Ab, A #/Bb; and
wherein the fourth musical note tone is a musical sharp or minor version of the second musical note tone and is selected from C #/Db, D #/Eb, E, F #/Gb, G #/Ab, A #/Bb.

5. The method of claim 1, further comprising:
determining that a second sound event has occurred for the second checkout system;
playing the second musical note tone for the second checkout system so that the first musical note is not played on the second checkout system.

6. The method of claim 1, wherein the first musical note is playable using different frequencies.

7. A non-transitory computer readable medium embodying computer program that when executed by a processor, the processor executes a method, the method comprising:
storing a first musical note tone assigned to a first checkout system, wherein the first musical note tone is different from a second musical note tone assigned to a second checkout system;
determining that a first sound event has occurred for the first checkout system; and
playing the first musical note tone for the first checkout system so that the first musical note tone is not played on the second checkout system and the second musical note is not played on the first checkout system.

8. The non-transitory computer readable medium of claim 7, wherein the first musical note tone is selected from a musical alphabet, and
wherein the second musical note tone is selected from the musical alphabet but is different from the first musical note.

9. The non-transitory computer readable medium of claim 8, wherein the first musical note tone is selected from C, D, E, F, G, A, B, and wherein the second musical note tone is also selected from C, D, E, F, G, A, B.

10. The non-transitory computer readable medium of claim 8, further comprising:
assigning a third musical note tone to the first checkout system;
assigning a fourth musical note tone to the second checkout system;
wherein the first and second musical note tones are a musical major notes selected from C, D, E, F, G, A, or B;
wherein the third musical note tone is a musical sharp or minor version of the first musical note tone and is selected from C #/Db, D #/Eb, E, F #/Gb, G #/Ab, A #/Bb; and
wherein the fourth musical note tone is a musical sharp or minor version of the second musical note tone and is selected from C #/Db, D #/Eb, E, F #/Gb, G #/Ab, A #/Bb.

11. The non-transitory computer readable medium of claim 10, wherein the third musical note tone is assigned to a third event for the first checkout system,
wherein the fourth musical note tone is assigned to a fourth event for the second checkout system,
wherein the first and third sound events comprises a scan event, warning message, or alert for the first checkout system, and
wherein the second and fourth sound events comprises a scan event, warning message, or alert for the second checkout system.

12. The non-transitory computer readable medium of claim 7, the method further comprising:
determining that a second sound event has occurred for the second checkout system;
playing the second musical note tone for the second checkout system so that the first musical note is not played on the second checkout system.

13. A system comprising:
memory;
at least one speaker; and
a processor configured for:
storing a first musical note tone assigned to a first checkout system, the first musical note tone being different from a second musical note tone assigned to a second checkout system;
determining that a first sound event has occurred for the first checkout system;
playing, via the at least one speaker, the first musical note tone for the first checkout system so that the first musical note tone is not played on the second checkout system and the second musical note is not played on the first checkout system.

14. The system of claim 13, wherein the first musical note tone is selected from a musical alphabet, and
wherein the second musical note tone is selected from the musical alphabet but is different from the first musical note.

15. The system of claim 14, wherein the first musical note tone is selected from C, D, E, F, G, A, B, and wherein the second musical note tone is also selected from C, D, E, F, G, A, B.

16. The system of claim 14, the processor further configured for:
assigning a third musical note tone to the first checkout system;
assigning a fourth musical note tone to the second checkout system;
wherein the first and second musical note tones are a musical major notes selected from C, D, E, F, G, A, or B;
wherein the third musical note tone is a musical sharp or minor version of the first musical note tone and is selected from C #/Db, D #/Eb, E, F #/Gb, G #/Ab, A #/Bb; and
wherein the fourth musical note tone is a musical sharp or minor version of the second musical note tone and is selected from C #/Db, D #/Eb, E, F #/Gb, G #/Ab, A #/Bb.

17. The system of claim 13, the processor further configured for:
determining that a second sound event has occurred for the second checkout system;
playing the second musical note tone for the second checkout system so that the first musical note is not played on the second checkout system.

18. The system of claim 13, wherein the first musical note is playable using different frequencies.

19. The system of claim 13, wherein none of the tones of the first checkout system are used on the second checkout system.
